(19) United States
(12) Patent Application Publication
(10) Pub. No.: US 2025/0119307 A1
(43) Pub. Date: Apr. 10, 2025

(54) AUTHENTICATION AND VALIDATION OF DIGITAL ASSETS

(71) Applicant: VerumSera, Clinton, UT (US)

(72) Inventors: James Hamilton MADSEN, Clinton, UT (US); Nathaniel Mason MILLS, Farmington, UT (US); Kenneth David FULTZ, Farmington, UT (US); Salvatore Joseph GIANI, Farmington, UT (US)

(21) Appl. No.: 18/906,956

(22) Filed: Oct. 4, 2024

Related U.S. Application Data
(60) Provisional application No. 63/542,899, filed on Oct. 6, 2023.

(51) Int. Cl. H04L 9/00; H04L 9/32

(52) U.S. Cl. CPC H04L 9/50; H04L 9/3239

(57) ABSTRACT

A service accesses an electronic file, which is associated with metadata. As a part of a repository transaction, the metadata is stored in a repository. The service triggers generation of an authentication hash on the electronic file and also triggers generation of a transaction hash on at least the repository transaction. The service then causes both the authentication hash and the transaction hash to be stored in a blockchain while refraining from causing the electronic file and the repository transaction from being stored in the blockchain.

### CROSS-REFERENCE TO RELATED APPLICATIONS

This application claims the benefit of and priority to U.S. Provisional Patent Application Ser. No. 63/542,899 filed on Oct. 6, 2023 and entitled “AUTHENTICATION AND VALIDATION OF DIGITAL ASSETS,” which application is expressly incorporated herein by reference in its entirety.

### BACKGROUND

The term “blockchain” generally refers to a type of immutable or unchangeable distributed digital ledger of transactions. These transactions are managed across any number of computers that are linked together in a P2P (peer to peer) network. One or more transactions are grouped together to formed a block. These transactions are managed using a consensus technique that enables the blocks and corresponding transactions to be synchronized across all of the computers in the P2P network. Each of the blocks in the blockchain includes a cryptographic hash of the immediately preceding block as well as timestamp and transaction data.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a computer system including: a processor system; and a storage system that includes instructions that are executable by the processor system to cause the computer system to: access an electronic file, wherein the electronic file is associated with metadata; as a part of a repository transaction, store the metadata in a repository; trigger generation of an authentication hash on the electronic file; trigger generation of a transaction hash on at least the repository transaction; and cause both the authentication hash and the transaction hash to be stored in a blockchain while refraining from causing the electronic file and the repository transaction from being stored in the blockchain.

In some aspects, the techniques described herein relate to a computer system including: a processor system; and a storage system that includes instructions that are executable by the processor system to cause the computer system to: access an electronic file; trigger generation of a verification hash on the electronic file; use the verification hash to search a blockchain, wherein the verification hash supposedly corresponds with an authentication hash that was supposedly previously uploaded to the blockchain; in response to determining that the authentication hash, which supposedly corresponds with the verification hash, has not been found as a part of said search, trigger a first alert indicating that the electronic file is not verifiable; in response to determining that the authentication hash has been found as a part of said search, trigger a second alert indicating that the electronic file is authentic; and in response to determining that the authentication hash has been found as the part of said search, return metadata for the electronic file.

In some aspects, the techniques described herein relate to a method including: accessing a first electronic file, wherein the first electronic file is associated with first metadata; as a part of a repository transaction, storing the first metadata in a repository; triggering generation of an authentication hash on the first electronic file; triggering generation of a transaction hash on at least the repository transaction; causing both the authentication hash and the transaction hash to be stored in a blockchain while refraining from causing the first electronic file and the repository transaction from being stored in the blockchain; accessing a second electronic file; triggering generation of a verification hash on the second electronic file; using the verification hash to search the blockchain, wherein the verification hash supposedly corresponds with the authentication hash associated with the first electronic file; in response to determining that the authentication hash, which supposedly corresponds with the verification hash, has not been found as a part of said search, triggering a first alert indicating that the second electronic file is not verifiable; in response to determining that the authentication hash has been found as a part of said search, triggering a second alert indicating that the second electronic file is authentic; and in response to determining that the authentication hash has been found as the part of said search, returning the first metadata.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example architecture for authenticating a digital asset.

FIG. 2 illustrates an example architecture for validating a digital asset.

FIG. 3 illustrates an example scenario in which a digital asset is being authenticated or validated.

FIG. 4A illustrates a flowchart of an example method for authenticating a digital asset.

FIG. 4B illustrates a flowchart of an example method for validating a digital asset.

FIG. 5 illustrates an example computer system that can be configured to perform any of the disclosed operations.

### DETAILED DESCRIPTION

There are various ways to establish the authenticity of a physical asset. For example, the asset can be examined and inspected to determine whether it is an original or a fake. The asset's chain of custody or authority can be reviewed to determine whether it has always been in secured possession.

Authenticating digital content is often more challenging than authenticating a physical asset. For instance, copies of a digital asset can be made and distributed. Subtle changes might be made to the asset, and those changes might not be discovered by a receiving party. There is a substantial need in the field of digital security to improve how digital assets are authenticated and validated.

The disclosed embodiments are configured to improve how a digital asset is authenticated and validated. Generally, the embodiments are designed to access or receive an electronic file, or a collection of data, of some sort. This electronic file, or data, is an example of a digital asset. As a part of the authentication set of operations, the embodiments trigger the generation of a hash on that electronic file. Concurrently, the embodiments store metadata (e.g., identifying information, provenance information, etc.) about the electronic file in a secure database and then generate a hash of the database, or at least a part of the database, such as a database transaction. The hash of the file and the hash of the transaction are then stored in a blockchain. Later, during the validation stage, the embodiments are able to access another electronic file and trigger the generation of a hash for that new file. The embodiments then use this new hash to conduct a search over the blockchain. If the embodiments discover a matching hash in the blockchain, then the embodiments are able to alert the user that the current electronic file is valid and authentic. Optionally, the embodiments may then trigger the retrieval of the metadata from the database.

By performing the disclosed operations, the embodiments bring about numerous benefits, advantages, and practical applications to the technical field of data security and integrity. For example, the disclosed embodiments cause only the hashes to be uploaded to the blockchain as opposed to the actual asset itself. Doing so significantly reduces the cost, both in terms of computing resources being used and monetary cost of uploading content to the blockchain. Similarly, the embodiments are able to refrain from having to take custody or control of the digital asset, thereby enabling a client to maintain control of the asset. The embodiments also significantly improve operations with respect to how the integrity of data is determined. In particular, the embodiments utilize the security of hashes and the blockchain to help determine whether an asset is authentic.

The embodiments also improve upon traditional techniques of using hash functions for data authentication. Traditionally, a hash will be generated for an asset, and then that hash will be stored in a central storage location. It is often the case that attempts are made to secure that location, but malicious entities are often trying to improperly gain access to that central store. If a hacking or malware attempt is successful, the malicious entities need only change or corrupt a single hash residing in the cache, resulting in the inability to subsequently use that hash to validate an asset. Thus, implementations that rely on a single source of protection offer an enhanced level of susceptibility in terms of hacking. By following the disclosed principles, the embodiments rely on the security benefits afforded via the blockchain, thereby eliminating a single source of susceptibility or vulnerability.

As yet another benefit, the disclosed embodiments provide a fast and efficient technique to notarize the truth of any subject/asset by making a hash of that asset. Some embodiments also beneficially record, via another blockchain transaction, who authorized the current blockchain transaction. This authorization record can provide a genealogy or auditable record detailing who authorized which transaction, thereby creating a chain of control, or a chain of authority, for each transaction. This chain of control can be used as additional proof of authenticity to make it even more difficult for bad actors to try to defraud the disclosed notarization system. Accordingly, these and numerous other benefits will now be described in more detail throughout the remaining portions of this disclosure.

### Example Architectures

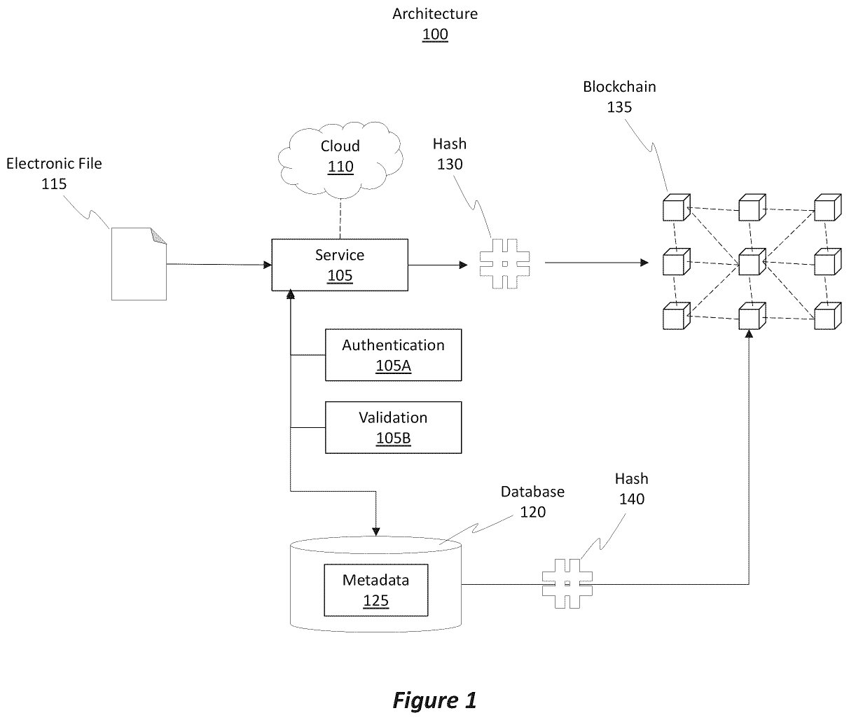

Attention will now be directed to FIG. 1, which illustrates an example architecture 100 that can be used to achieve the above-described benefits. Architecture 100 is shown as including a service 105.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine. The ML engine enables service 105 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train, retrain, or fine-tune the machine learning algorithm to dynamically perform the disclosed operations.

In some implementations, service 105 is a cloud service operating in a cloud environment 110. In some implementations, service 105 is a local service operating on a local device. In some implementations, service 105 is a hybrid service that includes a cloud component operating in the cloud and a local component operating on a local device. These two components can communicate with one another.

In some implementations, service 105 operates as an embedded component to another process, such as a word processor, spreadsheet program, any type of file program, any type of image program, audio program, or video program. More generally, in some implementations, service 105 can operate as an embedded component to another application or process. Thus, in these scenarios, service 105 can be an internal or embedded service. The embedded service can operate as a plug-in component for the application or process. For instance, by downloading and installing the plug-in, the embedded service can change the functionality of the application or process in a manner so as to enable the application or process to operate in an improved manner by now being able to perform the disclosed operations.

In some implementations, service 105 operates as an external service that resides or at least operates externally relative to another program or process. For instance, using the word processor example, service 105 can operate as an iframe in a website, and a document managed by the word processor can be uploaded to the iframe. In another scenario, service 105 can be a locally executing external process that executes independently relative to another application. Accordingly, in some scenarios, service 105 is an embedded service while in other scenarios service 105 is an externally operating service.

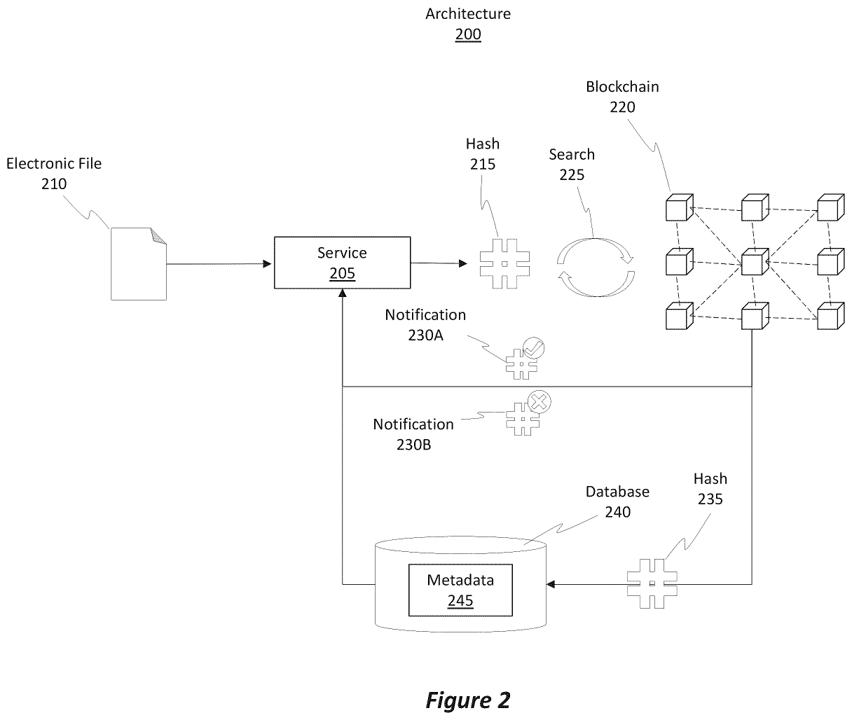

Service 105 is shown as including an authentication 105A component and a validation 105B component. FIG. 1 generally shows the authentication operations of service 105, and these authentication operations can be managed or performed by the authentication 105A component. On the other hand, FIG. 2 generally shows the validation operations of service 105, and these validation operations can be managed or performed by the validation 105B component.

Service 105 can operate as a type of blockchain processing engine. This engine (i.e. service 105) can incorporate an application programming interface (API), where any client can send one or more data fields (e.g., a unique identifier such as a customer identification). It is desirable that a cryptographic hash be generated for the client's digital asset because this hash can be used to help authenticate and validate the asset. In some implementations, clients can provide their own versions of the hash for their digital assets while in other implementations service 105 triggers the generation of the hash. Service 105 may generate the hash or, alternatively, service 105 may coordinate with another process to generate the hash. Any type of hash algorithm can be used, examples of which include, but certainly are not limited to, a message-digest algorithm (MD), a secure hash algorithm (SHA), cyclic redundancy check (CRC) algorithms, and so on, without limit.

Service 105 will then process the request and can optionally return to the client the address of where the hash has been recorded. The disclosed processes require no participation in cryptocurrency operations, no need for wallets, and little to no coding to interface with service 105.

Regarding how the request is processed, service 105 is generally tasked with accessing an electronic file 115 (i.e. a type of digital asset). Electronic file 115 can be any type of file. Examples of this file include, but are not limited to, any type of document (e.g., pdf, word, .txt file, etc.), any type of image, any type of video, any type of database, and so on. Accordingly, as used herein, the electronic file 115 should be broadly interpreted as covering or including any type of electronic data. As mentioned previously, service 105 can optionally operate in an embedded manner within the process that is managing the electronic file 115. In other scenarios, service 105 can operate in an external manner relative to the process that is managing the electronic file 115. If service 105 is operating as an embedded service and if the electronic file 115 is a document, service 105 can be an embedded plug-in operating in the same document processing application that is executing or hosting the document.

Service 105 accesses the electronic file 115 and stores, in a database 120, metadata 125 about the electronic file 115. This metadata 125 can include any type of information. Examples of metadata 125 include, but are not limited to, any type of provenance information, author information, time of creation information, storage location information, identification information (e.g., file identification information, information for the owner of the file, information for an entity or person who authenticated the file, signature data, etc.), or any other type of information. The metadata 125 is stored in the database 120, which is a secured database.

Service 105 also accesses the electronic file 115 and generates or causes the generation of a hash 130 for the electronic file 115. In some example scenarios, the hash 130 is a SHA-256 type of hash, an MD5 hash, a SHA-5 hash, a CRC32 hash, or any other type of hash, without limit. In this regard, service 105 includes a hash function that is able to map the electronic file 115 of any arbitrary size to a fixed-size value, which is in the form of the hash 130. In some implementations, though not necessarily all, a different hash type will be used depending on the type of the electronic file 115. As one example, if the electronic file 115 is a pdf, then a SHA-256 hash type may be used. Alternatively, if the electronic file 115 is an audio file, then a different hash type may be used.

In some scenarios, the type of hash algorithm that was used to generate the hash will be identified or recorded in the metadata 125 and thus can be queried. In some scenarios, the selection of the hash is performed in a random manner while in other scenarios, the selection is pre-determined. For instance, a set number of responses (e.g., perhaps 5) will use a first hash algorithm, and then the next set of responses will use a second hash algorithm, and so on. In another scenario, the type of the electronic file will determine which hash algorithm will be used, as mentioned above.

The hash 130 can be used to authenticate the electronic file 115. That is, the hash 130 digitally represents a state of the electronic file 115 at the time the hash 130 was generated. Provided no changes are subsequently made to the electronic file 115, another hash of the electronic file 115 could be made at a later time, and the two hashes should exactly match one another. If, on the other hand, a change is made to the electronic file 115 and a hash were to later be made on the electronic file 115, then the newly created hash and the originally created hash would not match with one another. In this manner, the hash 130 can be used as an authentication technique to determine whether the electronic file 115 (or, more generally, any electronic asset) has been modified since a designated point in time (e.g., the time corresponding to when the hash on the file was created).

In some implementations, timestamp data reflective of when the hash algorithm was used to generate the has can be included in the metadata 125. The metadata 125 can thus reflect the date and time the hash was generated.

Service 105 then causes the hash 130 to be uploaded to the blockchain 135. Any type of blockchain 135 can be used, without limit. In some cases, service 105 can select from multiple different hashes. In this regard, the principles disclosed herein can operate in a blockchain-agnostic manner. The hash 130 is uploaded to the blockchain 135 for secure management by the blockchain 135. In some implementations, the metadata 125 can also be updated to reflect timestamp information as to when the upload of the hash to the blockchain 135 occurred.

Blockchain 135 can be any type of blockchain, without limit (e.g., Bitcoin blockchain, Ethereum blockchain, and so on). A blockchain (e.g., blockchain 135) is a specific type of database. This database differs from traditional databases in that a blockchain stores data in blocks that are dispersed and chained together. When new data is entered into the blockchain, a new “block” is generated to house the data, and that new block is linked or chained with the existing blocks in the blockchain. The blocks are also distributed and repeated across different nodes in the blockchain in a decentralized manner, as shown by the various nodes (e.g., the cubes) that are interconnected in FIG. 1. Transactions that are recorded using the blockchain are immutable, meaning that once the data is entered, that data is permanent and is viewable by all the nodes in the blockchain.

Stated differently, a blockchain is a type of distributed ledger that is viewable by any node in the blockchain. Once information has been entered into the blockchain, it is almost impossible to change that data. Each block in the blockchain includes various pieces of information, including specific data, a hash for that block, and a hash of the previous block occurring previous in time to the current block (based on a chronological order). The type of the blockchain determines what type of data can be included in a block.

Hashes provide a strong framework to prevent against tampering. That being said, the use of hashes alone is not sufficient to prevent tampering. As such, most blockchains incorporate a principle referred to as “proof of work.” Proof of work operates to slow down or delay how quickly new blocks can be added to the blockchain. Because computers can generate hundreds of thousands of hashes each second, there is a chance (though small) that a fraudulent user could tamper with one block and then revalidate all subsequent blocks to ensure the hashes align with one another. By incorporating the proof of work principle, however, new blocks cannot be readily added or modified to the blockchain. In fact, some proof of work principles cause a 10 minute delay to occur before a new block can be added or modified to the blockchain. So, if one block was to be tampered with, that tampering would become readily apparent during the delay time period imposed by the proof of work principle. Accordingly, through the use of hashes and the proof of work principle, it is extremely difficult to tamper with the blockchain. Further, through the use of hashes and the globally distributed network of secure copies, the embodiments provide enhanced security measures.

Additionally, or alternatively, to the concept of proof of work, the disclosed embodiments further rely on “proof of stake” or “proof of authenticity.” In accordance with the disclosed principles, proof of work is not always necessary to provide the secure database needed to support the functions recited herein. The disclosed embodiments enable fast process times, which rely on a proof of stake model, primarily for the speed.

Blockchains provide yet another safeguard against tampering, where that safeguard occurs as a result of the blockchain being distributed amongst numerous different nodes. That is, blockchains rely on a peer to peer network of nodes as opposed to being managed by a centralized entity. When a new block is added to the blockchain, that new block is sent to every node that exists or that handles the blockchain. Then, each individual node verifies the authenticity of that new block, such as by comparing and analyzing the hash information. If the analysis indicates that the new block is authentic, then the new block is chained to the existing blocks and added to the blockchain. In this sense, all of the nodes in the blockchain create consensus regarding the authenticity of the blockchain (i.e. all of the nodes in the peer to peer network verify the authenticity of blocks in the blockchain, thereby agreeing as to which blocks are valid and which blocks are not valid).

Returning to FIG. 1, service 105 causes a hash 140 to be made for the database 120 and/or for transactions made with respect to the database 120. For instance, if metadata 125 has never been entered into the database 120 for an asset, then the hash 140 can be created for the entire new listing of information. If existing information for a digital asset already exists in the database 120 and new information is simply being appended to that record in the database 120, then only that new information (i.e. transaction information) can be hashed as opposed to hashing the entire database 120 or an entire record. Thus, if new data is simply being appended to existing data in the database 120, only the delta change is hashed. In any event, the hash 140 is also uploaded to the blockchain 135 for secure management. Thus, in some implementations, at least two distinct hashes are uploaded.

In some implementations, service 105 may impose a timing requirement as to when those two different hashes are required to be uploaded to the blockchain 135 relative to one another. For instance, once the first hash (e.g., either one of the hash 130 or the hash 140 is uploaded to the blockchain 135, service 105 may impose a timing requirement that the second hash (e.g., the other one of the hash 130 or the hash 140) is to be uploaded to the blockchain 135 within a threshold period of time. Uploading the two hashes to the blockchain 135 within a threshold level of timing proximity to one another can operate as another assurance regarding the authenticity of the disclosed operations.

In some implementations, the two hashes 130 and 140 are uploaded to the blockchain 135 within the same transaction. Thus, service 105 may purposefully delay uploading one of the hashes until the other hash is finalized. Service 105 can then wrap or bundle the two hashes together and upload the bundle to the blockchain 135 in a single transaction. In other implementations, two different transactions are used for the upload, within one transaction being made for one hash. In yet another implementation, service 105 may take a hash of a combination of the hash 130 and hash 140 and then upload the comprehensive hash to the blockchain 135.

FIG. 2 illustrates an architecture 200 that also includes a service 205. Service 205 corresponds to service 105 of FIG. 1. In FIG. 2, service 205 is primarily implementing its validation 105B component.

Service 205 receives or accesses an electronic file 210. In some cases, service 205 is being implemented as an iframe, a cloud service, or any type of service construct. Optionally, service 205 could be an embedded service. In this scenario, service 205 is tasked with determining whether this version of electronic file 210 is authentic, meaning, does this version of electronic file 210 exactly correspond to the electronic file 115 of FIG. 1.

To determine whether this correspondence exists, service 205 generates or causes the generation of a hash 215 for electronic file 210. If electronic file 210 is the same as electronic file 115, then the hash 215 should exactly match the hash 130 of FIG. 1. Recall further, the hash 130 was stored in the blockchain 135.

FIG. 2 also shows a blockchain 220. Blockchain 220 corresponds to blockchain 135 of FIG. 1. In some scenarios, blockchain 220 is the same as blockchain 135 because no additional blocks have been added. In other (more typical) scenarios, one or more blocks have been added to the blockchain, resulting in blockchain 220 being a larger blockchain relative to blockchain 135 but still preserving the blocks that were in blockchain 135.

Service 205 then uses the hash 215 to conduct a search 225 operation on the blockchain 220 in an attempt to determine whether the blockchain 220 includes a hash that matches the hash 215. Regarding the search, any type of block explorer service (corresponding to the respective blockchain) can be used to search the blockchain for specific information. In some cases, each node includes or is associated with an index of information. This index can also be searched in an attempt to find the relevant information. In some cases, the index can include metadata about the electronic file, such as perhaps the title of the electronic file or perhaps any other identifying information for the electronic file (e.g., author, place of creation, time of creation, signature on the electronic file, etc.).

If blockchain 220 does include a matching hash, then service 205 is notified (e.g., as shown by notification 230A) that a hash has been found. In some cases, service 205 is the entity that performs the search, so no notification is necessarily required when service 205 itself finds the match. Service 205 can then determine that the electronic file 210 is validated and is an authentic copy. On the other hand, if the search 225 reveals that blockchain 220 does not include a hash matching the hash 215, then service 205 is provided another notification 230B indicating that no such match was found. As above, if service 205 conducted the search, then no notification is necessarily required.

If no hash match is found, this can mean one of two things. The first meaning is that perhaps the electronic file 210 was never previously subjected to the authentication operations described in FIG. 1, so no hash was ever uploaded to the blockchain 220.

The second meaning is that a previous version of the electronic file 210 was hashed and that hash was uploaded to the blockchain 220, but the current version of the electronic file, as now represented by electronic file 210, has been modified relative to its original form, resulting in a different hash being produced. In this case, the electronic file 210 is not authentic and cannot be validated. In this example scenario, service 205 can optionally query the index of the blockchain in an attempt to obtain the identifying information for the electronic file, such as the file's file name, which was mentioned above and which can optionally be included in the index. If the index does reflect the correct file name but if the hashes do not align with one another, then service 205 can determine that the electronic file 210 must have been tampered with in some manner because although the file names match, the hashes do not match. Optionally, service 205 can perform an operation of attempting to determine what has changed in the electronic file. For instance, service 205 can optionally obtain the original file and perform a comparison between that original file and the electronic file 210. One or more differences may be detected between the two versions. Service 205 can optionally inform the user what those differences are so the user can be informed as to how the file changed.

If the electronic file 210 is authentic, as validated by the finding of a matching hash, then the embodiments can optionally retrieve the hash 235 corresponding to the database 240. Metadata 245 corresponding to the electronic file 210 can also be obtained and can be provided to a requesting entity. These retrievals can be performed by service 205 generating corresponding queries that have specific parameters in those queries. Execution of those queries will then enable service 205 to obtain the requested data.

It should be noted how the embodiments cause the hash to be stored in the blockchain, as opposed to storing the combination of the hash and the electronic file. Optionally, additional identifying information can also be stored in the blockchain, such as in the index of the blockchain. The information in the index may not be immutable like the information in the blocks, but the index information can be used by the service 205 to help sleuth as to reasons why an electronic file may have changed. By storing at least the hash, the embodiments are able to significantly reduce not only the processing time for uploading content to the blockchain but also reduce the expense that is incurred with respect to uploading content.

By following the disclosed operations, the embodiments are able to secure or preserve the truth for any type of digital asset. The embodiments are also able to provide easy validation for any item, memory, experience, provenance, ownership, authenticity, validity, permission, compliance, authorization, location, date, or any other piece of information or data type that could be used to determine the truth of an asset.

### Example Use Case(s)

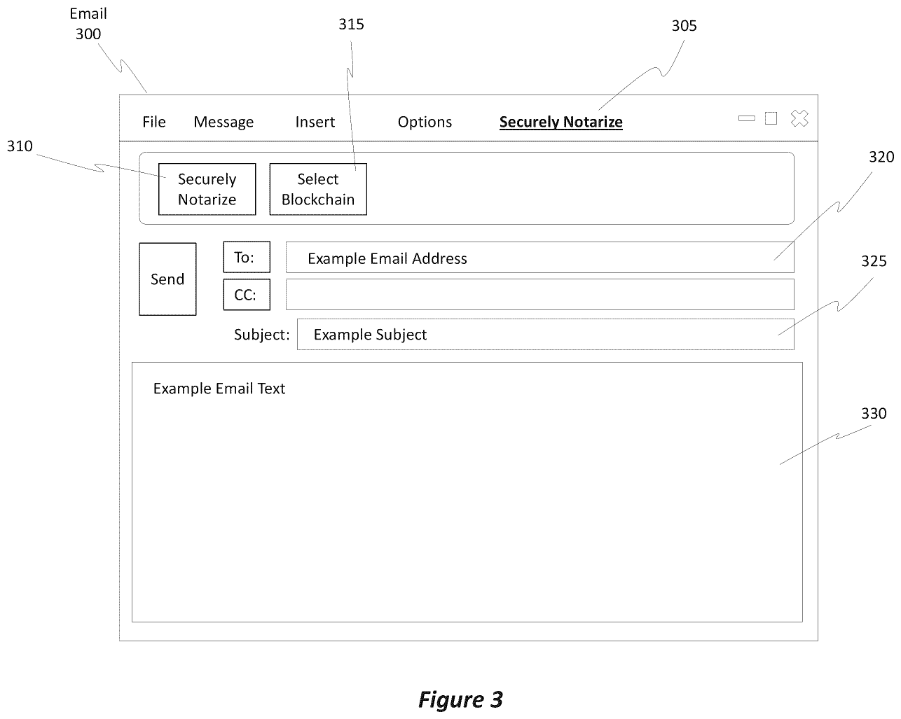

Attention will now be directed to FIG. 3, which illustrates an example use case in which the principles described herein can be utilized. FIG. 3 shows an example email 300 application in which the disclosed service has been embedded, as now shown by the option 305 to securely notarize the email 300, which is now considered to be a digital asset or digital/electronic file.

The option 305 shows a number of sub-options, such as option 310 and option 315. Option 310 corresponds to a selectable button included within the email 300 application. When the button is pressed, the service is triggered to generate the hash function, as described previously.

Option 315 corresponds to another button. When this button is pressed, the user is presented with an option to select a particular blockchain that is to be used. Recall, the embodiments are blockchain agnostic, but the user can be presented with an option to select a specific blockchain. In some cases, a default blockchain may be used unless otherwise specified, such as by selection of the option 315.

Email 300 is shown as including a number of fields, such as field 320, field 325, and field 330. Field 320 corresponds to the “to” field in which a user can specify an email address for a recipient. Field 325 corresponds to the “subject” field in which a user can specify the subject for the email. Field 330 corresponds to the email body in which the user can provide the text for the email. Other fields are also present but not labeled.

In this use case scenario, any number of the fields 320, 325, and 330, as well as potentially any other fields of the email 300 can have a hash generated for that individual field. That is, the embodiments may generate a hash for field 320; a separate hash for field 325; and a separate hash for field 330. The embodiments may then generate an overall hash for the combination of the above three hashes, resulting in a single, comprehensive hash. Additionally, in some implementations, the entirety of the email 300 can also be hashed.

Each individual hash as well as the collective hash(es) can then be uploaded to the blockchain, and corresponding metadata can be included in the disclosed database. These hashes can be used to determine whether any specific portion of the email 300 has been modified. For instance, because individual hashes were generated for the constituent parts of the email 300, the embodiments are able to determine whether any individual component of the email has been modified. The embodiments can also readily determine whether the email 300 has been modified simply by searching for the hash that was generated based on the collection of the individual hashes.

If the overall hash is not found, the embodiments may then be triggered to query each respective hash to determine which specific component or portion of the email 300 changed. For instance, it may be the case that the field 320 changed, but the fields 325 and 330 did not change. In this scenario, the validating hash (e.g., hash 215 in FIG. 2) for the field 320 would be different as compared to the original authenticating hash (e.g., hash 130 of FIG. 1). Similarly, the validating hash that is generated over the combination of the multiple, individual hashes would be different as compared to the original authenticating hash. On the other hand, the validating hash for the field 325 would be the same as compared to its corresponding original authenticating hash. Similarly, the validating hash for the field 330 would be the same as compared to its corresponding original authenticating hash. Thus, by performing hashes on the constituent parts of the email 300, the embodiments are able to determine which specific portions of the email 300 have changed. Thus, as mentioned previously, the disclosed service can perform sleuthing operations in an attempt to determine what has changed.

The embodiments also enable the option to securely send data and to incorporate multifactor authentication into the secure send button as an extra layer against misuse. In other words, a user is provided with the option to have multifactor authentication by clicking the secure send button each time the button is selected.

The disclosed principles can be used in numerous other types of use cases. As some non-limiting examples, the principles can be employed in any type of collectable use case, mining use case, legal use case, medical use case, political use case, food use case, genealogy use case, postal use case, identification use case, education and work use case, security use case, firearms use case, event ticketing use case, financial use case, and so on.

Using the collectable use case as an example, the embodiments can be used in a sports equipment or sports memorabilia scenario. To illustrate, the principles can be used to authenticate and validate the identity of any sports equipment, such as clothing, balls, shoes, gloves, and so on. The principles can be used to prove the date, time, and location of equipment use connected to the identity of the equipment. Data can be generated to prove experiences or memories that happened with the equipment, where that data connects the event to the identity of the equipment. The identity of the current owner can be verified or determined and can be connected to the identity of the equipment. The identity of the person authenticating can be used. This may be a third party authenticator or even the athlete. If an item was used or signed, that can be authenticated and verified and connected to the identity of the athlete.

The identity of third party authenticators can be involved if they are separate from the identity of the athlete. Data proving the date, time, location of a signed or used item can be notarized. Data proving experiences or memories that happened with the item can be recorded and notarized. One will appreciate how the disclosed principles can be used for sport collectibles, toy collectibles, movie collectibles, pop culture collectibles, recording artist collectibles, automobiles, fine art, coins, currency, stamps, celebrity collectibles (e.g., local, national, and international), designer shoes, luxury/designer clothes, glasses, bags, watches, hunting collectibles/memorabilia (including registered hunting tags), and even fine jewelry.

The provenance of mining material can be used to authenticate raw materials, such as loose diamonds. Any type of legal document can be notarized, including depositions and signed contracts. Medical procedure recordings, medical and dental records can be notarized. Political data, including voting registration and voter information, can be notarized.

Food items regulated by the FDA can have provenance information notarized for each food item and each step for that food item, such as from field to table. Genealogy records can be notarized to document the truth of deceased persons to reduce novice errors by creating a turn back point. Postal, including parcels and letters and all data related to creation, tracking, and postmarking of any form of postage paid, can be notarized. Identification corporate certificates, personal credentials of any kind, and a personal identity aggregator can be notarized.

Education and work credentials (e.g., a transcript) of any kind can be notarized. Work experience can be validated. Proficiency measurements related to education or work experience can be validated. Security access authorization, orders for approved access, approving authority information can be validated. Firearms verification and collectible, music, video, hearing aids, event ticketing systems (e.g., to prevent scalping), dentures, medical devices, guaranteed organic products, government documents (e.g., seals or titles), tax paid verification, tariffs, VAT, or import tax, taxidermy, financial, bearer bonds, title insurance, charitable giving (e.g., verify dollars given and to whom), real estate, CarFax, “Youtag” (e.g., verified memories or events for an individual), pure bred pedigree for livestock/pets, patents, digital memorial (vgraveside), cyber security (e.g., router indices, DNS server updates, email, session tokens, secure send/save) can all be notarized.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

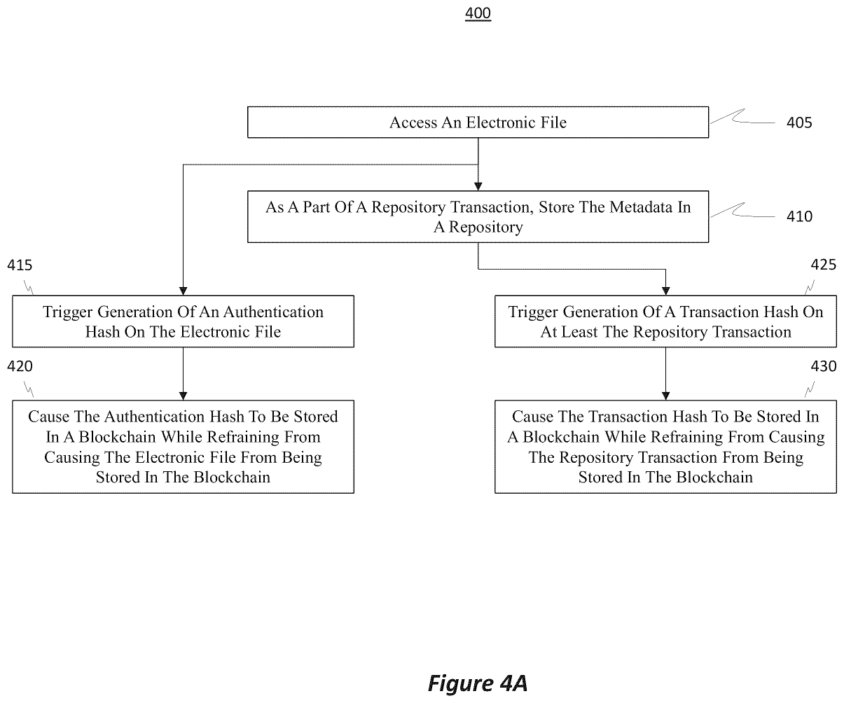

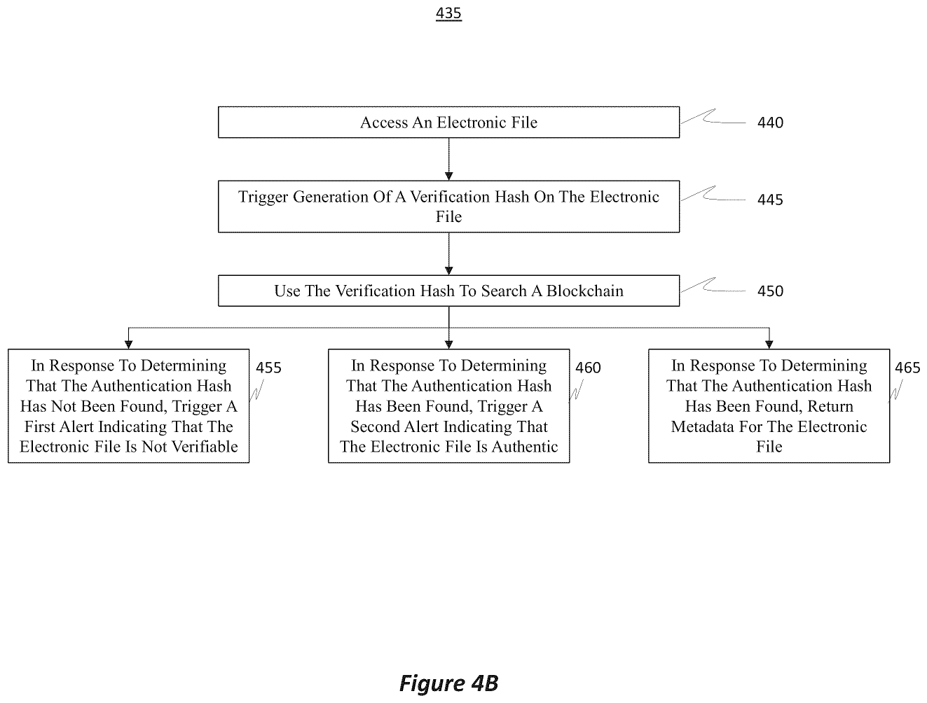

Attention will now be directed to FIG. 4A, which illustrates a flowchart of an example method 400 for triggering the generation of an authentication hash. Method 400 can be implemented within the architecture 100 of FIG. 1, and in particular can be implemented by service 105 of FIG. 1.

Method 400 includes an act (act 405) of accessing an electronic file (e.g., electronic file 115). This electronic file can be any type of digital asset. Notably, the electronic file is associated with metadata (e.g., metadata 125). The metadata can include any type of identifying information, such as title, creator, timestamp information (e.g., creation timestamp, modification timestamp, etc.), place of creation or modification, and so on.

As a part of a repository transaction, act 410 includes storing the metadata in a repository (e.g., database 120). This metadata can also include any type of provenance information, ownership or creator information, management information, file information, and so on, without limit.

Act 415 includes triggering generation of an authentication hash (e.g., hash 130) on the electronic file. Note, act 415 can be performed asynchronously relative to act 410. In some implementations, service 105 of FIG. 1 generates the hash. In other implementations, service 105 coordinates with a third-party process to generate the hash. As mentioned previously, the hash can be of any type. Often, the hash is a SHA-256 type of hash. Optionally, the selection of the hash type may be based on a determined type for the electronic file. In some cases, the selection of the hash may be based on the metadata associated with the electronic file. For instance, particular times, days, months, or years associated with a file may cause one type of hash to be selected over another type. Attributes associated with an author's name can also be used to select the hash type. Indeed, selection of the hash type may be based on any set of predefined criteria. Randomization factors can also be used to select which hash algorithm will be used. Optionally, the metadata can include a parameter that identifies which hash algorithm was used. In some implementations, the characteristics of the hash itself might enable the service to determine which hash algorithm was used.

Act 420 then involves causing the authentication hash to be stored in a blockchain while refraining from causing the electronic file from being stored in the blockchain. Doing so significantly improves and speeds up the uploading process because a reduced amount of data is involved (e.g., the data for a hash is smaller as compared to the data for the electronic file).

Act 425 includes triggering generation of a transaction hash on at least the repository transaction. Optionally, this hash can be generated for an entire database record or, in some extreme scenarios, for the entire database. Act 425 is performed after act 410, but act 425 can be performed asynchronously relative to acts 415 and 425. In some implementations, act 425 is performed before, after, or during the performance of either acts 415 or 420.

Act 430 then includes causing the transaction hash to be stored in the blockchain while refraining from causing the repository transaction from being stored in the blockchain. Act 430 is performed after act 425.

As mentioned, the above acts can be performed by a service, and, in some cases, the service is an embedded service operating in an application that is also hosting the electronic file. Optionally, the authentication hash (and the transaction hash) is generated using a hash algorithm. The hash algorithm may be one of many that are available for use. The selection of the hash algorithm can be based on one or a combination of multiple factors, such as, information included in the metadata (e.g., file name, creation information, timestamp data, etc.), information included in the electronic file itself (e.g., perhaps a specific line or feature is selected within the electronic file, and then the algorithm is selected based on what that content is), the determined type of the electronic file, or even based on a randomization factor.

FIG. 4B illustrates a flowchart of an example method 435 for generating a validation hash and for using that validation hash to validate a digital asset. Method 435 can also be implemented by service 105.

Method 435 includes an act (act 440) of accessing an electronic file. The electronic file 210 of FIG. 2 is representative of the electronic file in act 440. At this stage, it is typically unknown whether the electronic file 210 is authentic. To determine its authenticity, the embodiments perform the remaining acts of method 435.

Act 445 includes triggering generation of a verification hash (e.g., hash 215) on the electronic file. The hash type that is relied on for this transaction is selected to be the same hash type as was previously used. In one scenario, metadata about the electronic file may be obtained, and that metadata can be used to determine which hash type was previously used during the potential authentication stage. In some cases, metadata included with the electronic file is used to determine the hash type.

As various examples, it may be the case that a different hash type is used under different circumstances. For instance, if the electronic file is a type of pdf document, a first hash type may be used. On the other hand, if the electronic file is a type of image file, then a second hash type may be used. As yet another example, if the electronic file is a type of audio file, then a third hash type may be used. In these scenarios, the embodiments can dynamically select a hash type based on the type of the electronic file, and this selection can occur without having to consult operations that were performed during an earlier authentication step.

In some implementations, the hash type can be selected based on content included within the electronic file. As one simplistic example, if the electronic file is a type of document, the selection of the hash type may be dependent on which letter in the alphabet is the first letter provided in the document. For instance, the letters A-G may trigger the use of a SHA-256 hash type. The letters H-M may trigger a second hash type, and so on. If the first letter in the document falls within the A-G range, then the SHA-256 hash type is used. This same rule may have been applied when the authentication process was previously performed (if it was performed) on the electronic file.

Act 450 then involves using the verification hash to search a blockchain. This verification hash supposedly corresponds with an authentication hash that was supposedly previously uploaded to the blockchain. Here, the embodiments are attempting to determine whether this electronic file was previously authenticated, as described by the steps recited in FIG. 4A. If the current version of the electronic file was previously authenticated and if this current version is the same as the authenticated version, then the validation hash should match an authentication hash that was previously uploaded to the blockchain.

For example, in response to determining that the authentication hash, which supposedly corresponds with the verification hash, has not been found as a part of the search, act 455 includes triggering a first alert indicating that the electronic file is not verifiable. Because no matching hash was found, the embodiments are able to determine either that the current version of the electronic file has been modified as compared to a previously authenticated version (and an authentication hash does exist on the blockchain) or, alternatively, this electronic file was never previously authenticated (and an authentication hash does not exist on the blockchain). In some scenarios, when no match is found, the embodiments automatically trigger a watermark or some other flag to be associated with the electronic file. For instance, the name of the file may be altered to include some appended language, such as the following “document name-UNVERIFIED DOCUMENT.” Of course, other language could be used. Similarly, a watermark may be automatically added to the document if the document is not validated. The file's metadata can also be modified to include an indication that this file is not validated. Thus, the embodiments can operate to transform the electronic document in some manner so as to clearly indicate it is unverified. In some cases, one or more alerts can be triggered and transmitted to interested parties to inform those parties of the unverified document.

On the other hand, in response to determining that the authentication hash has been found as a part of the search, act 460 includes triggering a second alert indicating that the electronic file is authentic. Notably, the verification hash matches the authentication hash.

In response to determining that the authentication hash has been found as the part of the search, act 465 includes returning metadata for the electronic file. This metadata can be obtained from the database 240 of FIG. 2. The embodiments can optionally query the database 240 to determine whether any metadata has been saved for this electronic file. The embodiments can optionally obtain a version of the database corresponding to when the metadata for the electronic file was saved in the database. In order to ensure that the database has not been compromised, the embodiments can retrieve the hash that was previously generated for the repository or the repository transaction. The embodiments can also trigger the generation of a hash on the database. A comparison between those two hashes can then be performed to ensure that the information included in the database has not been tampered with. In this manner, the embodiments can then validate an electronic file and can also obtain metadata about that electronic file.

A hash algorithm used to generate the verification hash can be identified using the metadata, which is stored in a repository and which can optionally include author information for the electronic file. Optionally, file metadata included with the electronic file can be used to select the hash algorithm that generates the verification hash. As another option, a determined type of the electronic file can be used to select the hash algorithm that generates the verification hash. As another option, information included within the electronic file can be used to select the hash algorithm that generates the verification hash.

Optionally, determining that the authentication hash has not been found as a part of the search can include a number of acts. One act includes determining a file name of the electronic file. Another act includes searching an index of the blockchain using the file name as a search parameter. Another act includes identifying the file name in the index of the blockchain. Yet another act includes, despite the file name being identified in the index of the blockchain, determining that the electronic file is not verifiable.

Another act can include obtaining an authentic version of the electronic file using the file name. The embodiments can then compare the authentic version of the electronic file against the electronic file. The embodiments can identify one or more differences that exist between the authentic version of the electronic file and the electronic file. The embodiments can then trigger an alert that details the one or more differences.

### Example Computer Systems

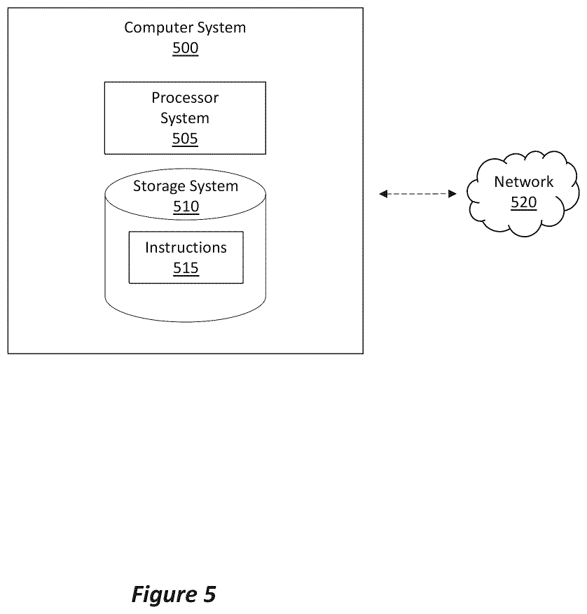

Attention will now be directed to FIG. 5 which illustrates an example computer system 500 that may include and/or be used to perform any of the operations described herein. Computer system 500 may take various different forms. For example, computer system 500 may be embodied as a tablet, a desktop, a laptop, a mobile device, or a standalone device, such as those described throughout this disclosure. Computer system 500 may also be a distributed system that includes one or more connected computing components/devices that are in communication with computer system 500. Computer system 500 can implement service 105 of FIG. 1.

In its most basic configuration, computer system 500 includes various different components. FIG. 5 shows that computer system 500 includes a processor system 505 that includes one or more processor(s) (aka a “hardware processing unit”) and a storage system 510.

Regarding the processor(s) of the processor system 505, it will be appreciated that the functionality described herein can be performed, at least in part, by one or more hardware logic components. For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 500. The different components, modules, engines, and services described herein may be implemented as objects or processors that execute on computer system 500 (e.g. as separate threads).

Storage system 510 may include physical system memory, which may be volatile, non-volatile, or some combination of the two. The term “memory” may also be used herein to refer to non-volatile mass storage such as physical storage media. If computer system 500 is distributed, the processing, memory, and/or storage capability may be distributed as well.

Storage system 510 is shown as including executable instructions 515. The executable instructions 515 represent instructions that are executable by the processor(s) of processor system 505 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 500 may also be connected (via a wired or wireless connection) to external sensors (e.g., one or more remote cameras) or devices via a network 520. For example, computer system 500 can communicate with any number devices or cloud services to obtain or process data. In some cases, network 520 may itself be a cloud network. Furthermore, computer system 500 may also be connected through one or more wired or wireless networks to remote/separate computer systems(s) that are configured to perform any of the processing described with regard to computer system 500.

A “network,” like network 520, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 500 will include one or more communication channels that are used to communicate with the network 520. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The disclosed embodiments can be implemented in numerous different ways, as described in the various different clauses recited below.

Clause 1. A computer system comprising: a processor system; and a storage system that includes instructions that are executable by the processor system to cause the computer system to: access an electronic file, wherein the electronic file is associated with metadata; as a part of a repository transaction, store the metadata in a repository; trigger generation of an authentication hash on the electronic file; trigger generation of a transaction hash on at least the repository transaction; and cause both the authentication hash and the transaction hash to be stored in a blockchain while refraining from causing the electronic file and the repository transaction from being stored in the blockchain.

Clause 2. The computer system of any of the preceding clauses, wherein the metadata includes at least one of provenance information for the electronic file, ownership information for the electronic file, or creator information for the electronic file.

Clause 3. The computer system of any of the preceding clauses, wherein the computer system generates the authentication hash on the electronic file.

Clause 4. The computer system of any of the preceding clauses, wherein the computer system generates the transaction hash on at least the repository transaction.

Clause 5. The computer system of any of the preceding clauses, wherein a third-party process generates the authentication hash on the electronic file.

Clause 6. The computer system of any of the preceding clauses, wherein causing both the authentication hash and the transaction hash to be stored in the blockchain while refraining from causing the electronic file and the repository transaction from being stored in the blockchain is performed by a service, and wherein the service is an embedded service operating in an application that is also hosting the electronic file.

Clause 7. The computer system of any of the preceding clauses, wherein the authentication hash is generated using a hash algorithm, and wherein selection of the hash algorithm is based on information included in the metadata.

Clause 8. The computer system of any of the preceding clauses, wherein the authentication hash is generated using a hash algorithm, and wherein selection of the hash algorithm is based on information included in the electronic file.

Clause 9. The computer system of any of the preceding clauses, wherein the authentication hash is generated using a hash algorithm, and wherein selection of the hash algorithm is based on a determined type of the electronic file.

Clause 10. The computer system of any of the preceding clauses, wherein the authentication hash is generated using a hash algorithm, and wherein selection of the hash algorithm is based on a randomization factor.

Clause 11. A computer system comprising: a processor system; and a storage system that includes instructions that are executable by the processor system to cause the computer system to: access an electronic file; trigger generation of a verification hash on the electronic file; use the verification hash to search a blockchain, wherein the verification hash supposedly corresponds with an authentication hash that was supposedly previously uploaded to the blockchain; in response to determining that the authentication hash, which supposedly corresponds with the verification hash, has not been found as a part of said search, trigger a first alert indicating that the electronic file is not verifiable; in response to determining that the authentication hash has been found as a part of said search, trigger a second alert indicating that the electronic file is authentic; and in response to determining that the authentication hash has been found as the part of said search, return metadata for the electronic file.

Clause 12. The computer system of any of the preceding clauses, wherein a hash algorithm used to generate the verification hash is identified using the metadata, which is stored in a repository.

Clause 13. The computer system of any of the preceding clauses, wherein determining that the authentication hash has not been found as a part of said search further includes: determining a file name of the electronic file; searching an index of the blockchain using the file name as a search parameter; identifying the file name in the index of the blockchain; and despite the file name being identified in the index of the blockchain, determining that the electronic file is not verifiable.

Clause 14. The computer system of any of the preceding clauses, wherein determining that the authentication hash has not been found as a part of said search further includes: obtaining an authentic version of the electronic file using the file name; comparing the authentic version of the electronic file against the electronic file; identifying one or more differences that exist between the authentic version of the electronic file and the electronic file; and triggering an alert that details the one or more differences;

Clause 15. The computer system of any of the preceding clauses, wherein file metadata included with the electronic file is used to select a hash algorithm that generates the verification hash.

Clause 16. The computer system of any of the preceding clauses, wherein a determined type of the electronic file is used to select a hash algorithm that generates the verification hash.

Clause 17. The computer system of any of the preceding clauses, wherein information included within the electronic file is used to select a hash algorithm that generates the verification hash.

Clause 18. The computer system of any of the preceding clauses, wherein the metadata includes author information for the electronic file.

Clause 19. A method comprising: accessing a first electronic file, wherein the first electronic file is associated with first metadata; as a part of a repository transaction, storing the first metadata in a repository; triggering generation of an authentication hash on the first electronic file; triggering generation of a transaction hash on at least the repository transaction; causing both the authentication hash and the transaction hash to be stored in a blockchain while refraining from causing the first electronic file and the repository transaction from being stored in the blockchain; accessing a second electronic file; triggering generation of a verification hash on the second electronic file; using the verification hash to search the blockchain, wherein the verification hash supposedly corresponds with the authentication hash associated with the first electronic file; in response to determining that the authentication hash, which supposedly corresponds with the verification hash, has not been found as a part of said search, triggering a first alert indicating that the second electronic file is not verifiable; in response to determining that the authentication hash has been found as a part of said search, triggering a second alert indicating that the second electronic file is authentic; and in response to determining that the authentication hash has been found as the part of said search, returning the first metadata.

Clause 20. The method of any of the preceding clauses, wherein the first metadata includes author information.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
a processor system; and
a storage system that includes instructions that are executable by the processor system to cause the computer system to:
access an electronic file, wherein the electronic file is associated with metadata;
as a part of a repository transaction, store the metadata in a repository;
trigger generation of an authentication hash on the electronic file;
trigger generation of a transaction hash on at least the repository transaction; and
cause both the authentication hash and the transaction hash to be stored in a blockchain while refraining from causing the electronic file and the repository transaction from being stored in the blockchain.

2. The computer system of claim 1, wherein the metadata includes at least one of provenance information for the electronic file, ownership information for the electronic file, or creator information for the electronic file.

3. The computer system of claim 1, wherein the computer system generates the authentication hash on the electronic file.

4. The computer system of claim 1, wherein the computer system generates the transaction hash on at least the repository transaction.

5. The computer system of claim 1, wherein a third-party process generates the authentication hash on the electronic file.

6. The computer system of claim 1, wherein causing both the authentication hash and the transaction hash to be stored in the blockchain while refraining from causing the electronic file and the repository transaction from being stored in the blockchain is performed by a service, and wherein the service is an embedded service operating in an application that is also hosting the electronic file.

7. The computer system of claim 1, wherein the authentication hash is generated using a hash algorithm, and wherein selection of the hash algorithm is based on information included in the metadata.

8. The computer system of claim 1, wherein the authentication hash is generated using a hash algorithm, and wherein selection of the hash algorithm is based on information included in the electronic file.

9. The computer system of claim 1, wherein the authentication hash is generated using a hash algorithm, and wherein selection of the hash algorithm is based on a determined type of the electronic file.

10. The computer system of claim 1, wherein the authentication hash is generated using a hash algorithm, and wherein selection of the hash algorithm is based on a randomization factor.

11. A computer system comprising:
a processor system; and
a storage system that includes instructions that are executable by the processor system to cause the computer system to:
access an electronic file;
trigger generation of a verification hash on the electronic file;
use the verification hash to search a blockchain, wherein the verification hash supposedly corresponds with an authentication hash that was supposedly previously uploaded to the blockchain;
in response to determining that the authentication hash, which supposedly corresponds with the verification hash, has not been found as a part of said search, trigger a first alert indicating that the electronic file is not verifiable;
in response to determining that the authentication hash has been found as a part of said search, trigger a second alert indicating that the electronic file is authentic; and
in response to determining that the authentication hash has been found as the part of said search, return metadata for the electronic file.

12. The computer system of claim 11, wherein a hash algorithm used to generate the verification hash is identified using the metadata, which is stored in a repository.

13. The computer system of claim 11, wherein determining that the authentication hash has not been found as a part of said search further includes:
determining a file name of the electronic file;
searching an index of the blockchain using the file name as a search parameter;
identifying the file name in the index of the blockchain; and
despite the file name being identified in the index of the blockchain, determining that the electronic file is not verifiable.

14. The computer system of claim 13, wherein determining that the authentication hash has not been found as a part of said search further includes:
obtaining an authentic version of the electronic file using the file name;
comparing the authentic version of the electronic file against the electronic file;
identifying one or more differences that exist between the authentic version of the electronic file and the electronic file; and
triggering an alert that details the one or more differences.

15. The computer system of claim 11, wherein file metadata included with the electronic file is used to select a hash algorithm that generates the verification hash.

16. The computer system of claim 11, wherein a determined type of the electronic file is used to select a hash algorithm that generates the verification hash.

17. The computer system of claim 11, wherein information included within the electronic file is used to select a hash algorithm that generates the verification hash.

18. The computer system of claim 11, wherein the metadata includes author information for the electronic file.

19. A method comprising:
accessing a first electronic file, wherein the first electronic file is associated with first metadata;
as a part of a repository transaction, storing the first metadata in a repository;
triggering generation of an authentication hash on the first electronic file;
triggering generation of a transaction hash on at least the repository transaction;
causing both the authentication hash and the transaction hash to be stored in a blockchain while refraining from causing the first electronic file and the repository transaction from being stored in the blockchain;
accessing a second electronic file;
triggering generation of a verification hash on the second electronic file;
using the verification hash to search the blockchain, wherein the verification hash supposedly corresponds with the authentication hash associated with the first electronic file;
in response to determining that the authentication hash, which supposedly corresponds with the verification hash, has not been found as a part of said search, triggering a first alert indicating that the second electronic file is not verifiable;
in response to determining that the authentication hash has been found as a part of said search, triggering a second alert indicating that the second electronic file is authentic; and
in response to determining that the authentication hash has been found as the part of said search, returning the first metadata.

20. The method of claim 19, wherein the first metadata includes author information.
